(19) United States
(12) Patent Application Publication
(10) Pub. No.: US 2011/0233450 A1
(43) Pub. Date: Sep. 29, 2011

(54) CONDUCTIVE POLYMER AND METHOD FOR PRODUCING THE SAME, CONDUCTIVE POLYMER DISPERSION, AND SOLID ELECTROLYTIC CAPACITOR AND METHOD FOR PRODUCING THE SAME

(75) Inventors: Tomoki NOBUTA, Miyagi (JP); Yasuhisa SUGAWARA, Miyagi (JP); Yuji YOSHIDA, Miyagi (JP); Satoshi SUZUKI, Miyagi (JP); Yasuhiro TOMIOKA, Miyagi (JP)

(73) Assignee: NEC TOKIN CORPORATION, Miyagi (JP)

(21) Appl. No.: 13/070,011

(22) Filed: Mar. 23, 2011

(30) Foreign Application Priority Data
Mar. 25, 2010 (JP) 2010-070142

(51) Int. Cl. H01G 9/022; H01B 1/12

(52) U.S. Cl. 252/62.2

(57) ABSTRACT

The present exemplary embodiment provides a conductive polymer having high conductivity and a method for producing the same, and a conductive polymer dispersion, and further provides a solid electrolytic capacitor having low ESR and a method for producing the same. A conductive polymer is produced by a method including the steps of dissolving a sulfonic acid group-containing resin having a weight average molecular weight of 2,000 or more and 50,000 or less and a compound represented by the following formula (1) in a solvent; mixing at least one monomer selected from pyrrole, thiophene, and derivatives thereof in an obtained solution; subjecting the monomer to chemical oxidative polymerization, using a persulfate, to obtain a conductive polymer; and washing the conductive polymer to remove the compound represented by the formula (1) contained in the conductive polymer.

CₙHₙ₊₂(OH)ₙ (1)

wherein n represents an integer of 3 to 6.

This application is based upon and claims the benefit of priority from Japanese patent application No. 2010-070142, filed on Mar. 25, 2010, the disclosure of which is incorporated herein in its entirety by reference.

### BACKGROUND OF THE INVENTION

1. Field of the Invention

The present exemplary embodiment relates to a conductive polymer and a method for producing the same, a conductive polymer dispersion, and a solid electrolytic capacitor using the conductive polymer and a method for producing the same.

2. Description of the Related Art

Conductive polymer materials are used for the electrodes of capacitors, the electrodes of dye-sensitized solar cells, organic thin film solar cells, and the like, the electrodes of electroluminescent displays, and the like. Materials containing conductive polymers obtained by polymerizing pyrrole, thiophene, 3,4-ethylenedioxythiophene, aniline, and the like are known as such conductive polymer materials. Conductive polymers have different physical properties, such as conductivity, depending on many factors, such as the method for producing them, and their composition, even if their types are the same, and therefore, various studies have been made.

In addition, a conductive polymer dispersion is generally provided as a dispersion or a solution in an aqueous solvent, or a solution in an organic solvent, and is used as a conductive polymer by removing the solvent in use. But, the physical properties of the obtained conductive polymer are different depending on the state of the conductive polymer dispersion, and therefore, various studies have been made on the method for producing a conductive polymer dispersion.

JP7-90060A discloses techniques regarding a solution (dispersion) of polythiophene and a method for producing the same, and use thereof in the antistatic treatment of a plastic molded article. This dispersion of polythiophene includes water or a mixture of a water-miscible organic solvent and water as a dispersion medium, polythiophene composed of the structural unit of 3,4-dialkoxythiophene, and a polyanion derived from polystyrenesulfonic acid having a molecular weight in the range of 2,000 to 500,000. The polythiophene is obtained by chemical oxidative polymerization in the presence of a polyanion of polystyrenesulfonic acid having a molecular weight in the range of 2,000 to 500,000. It is said that thus, a transparent antistatic film can be formed.

JP2004-59666A discloses techniques regarding a water dispersion of a composite of poly(3,4-dialkoxythiophene) and a polyanion and a method for producing the same, and a coating composition containing the water dispersion, and a coated substrate including a transparent conductive film formed by coating with the composition. This water dispersion is obtained by polymerizing 3,4-dialkoxythiophene in an aqueous solvent in the presence of a polyanion, using peroxodisulfuric acid as an oxidant. Alternatively, this water dispersion is obtained by subjecting 3,4-dialkoxythiophene to chemical oxidative polymerization in an aqueous solvent in the presence of a polyanion, using an oxidant, with the pH of the reaction solution decreased by adding an acid selected from the group consisting of water-soluble inorganic acids and organic acids. It is said that thus, a conductive thin film with excellent transparency can be formed.

International Publication No. WO 2009/131012 discloses techniques regarding a dispersion of a conductive composition, a conductive composition, and a solid electrolytic capacitor using the above conductive composition as a solid electrolyte. The dispersion of a conductive composition is characterized by containing a conductive polymer obtained by subjecting thiophene or a derivative thereof to oxidative polymerization in water or in an aqueous solution of a mixture of a water-miscible solvent in the presence of polystyrenesulfonic acid and at least one selected from the group consisting of a phenolsulfonic acid novolak resin and a sulfonated polyester, and a high boiling point solvent. It is said that the obtained conductive composition has high conductivity and excellent heat resistance and is suitable for use as the electrolyte of a solid electrolytic capacitor, and a solid electrolytic capacitor with small ESR and with high reliability under high temperature conditions can be provided by using the conductive composition as a solid electrolyte.

JP2004-514753A relates to a dispersible polymer powder and the production and use of the same, and discloses a technique for producing a water-dispersible powder mainly having polymer T having a repeating thiophene unit and at least one another polyanion polymer P, in which a dispersion or a solution having polymer T having a repeating thiophene unit and at least one another polyanion polymer P is mixed with a compound that forms an azeotrope with water, water is removed by azeotropic distillation, and the obtained polymer is isolated and dried.

JP2009-1624A discloses techniques regarding the provision of a conductive polymer having high conductivity, high transparency, and excellent heat resistance, and applications, such as an antistatic material and a solid electrolytic capacitor, utilizing the excellent properties of the conductive polymer. Polystyrenesulfonic acid in which the number average molecular weight is 50,000 to 1,000,000, the total residual amount (total content) of bromine and chlorine is 500 ppm or less, and the residual amount (content) of a styrenesulfonic acid monomer is 1% or less by weight is used as a dispersant and dopant. This polystyrenesulfonic acid functions as an excellent dispersant and uniformly disperses an oxidant and a polymerizable monomer during the synthesis of the conductive polymer, that is, during chemical oxidative polymerization, and is taken in the synthesized conductive polymer as a dopant to exhibit excellent conductivity. It is considered that the above polystyrenesulfonic acid functioning as an excellent dispersant is a factor that can synthesize a conductive polymer having high transparency, high conductivity, and excellent heat resistance.

JP5-262981A discloses a water-dispersible polyaniline composition and a method for producing the same. The water-dispersible polyaniline composition can be obtained by a simple method of adding an oxidant to an aqueous solution containing an aniline salt and polystyrene sulfonate having a molecular weight of 50,000 or more, with the pH maintained in the range of 2 to 5, to perform oxidation polymerization. In other words, the water-dispersible polyaniline composition is a water-dispersible polyaniline composition characterized by being composed of polyaniline containing a low molecular protonic acid as a dopant, and polystyrene sulfonate having a molecular weight of 50,000 or more as a water dispersant, obtained by adding an oxidant to an aqueous solution containing an aniline salt and polystyrene sulfonate having a molecular weight of 50,000 or more at a molar ratio of (the monomer unit of polystyrene sulfonate)/(aniline) of 0.5 or more and 10 or less, with the pH maintained in the range of 2 to 5, to perform oxidation polymerization. It is said that the obtained polyaniline composition has a small particle diameter, and a water dispersion of the polyaniline composition is excellent in dispersibility, stability over time, molding, and processability.

JP2002-206022A discloses techniques regarding polythiophene and a method for producing the same. In this production method, a) thiophene, b) at least one compound containing one or more sulfonic acid groups, c) at least one oxidant, d) at least one phase transfer catalyst, and e) one or more catalysts as desired are reacted in at least one anhydrous solvent or low water content solvent at a temperature of 0 to 150° C., and then the product is treated. The obtained polythiophene is in the form of the solid, dispersion, or solution. Here, it is said that the phase transfer catalyst increases the solubility of the oxidant in the solvent. It is described that examples of a suitable phase transfer catalyst include a compound that complexes an alkali metal ion, or an ionic compound containing a long-chain alkyl group that has a counter ion soluble in the solvent and thus increases the solubility of the oxidant. An advantage of such a production method is that the method can produce a solvent-containing anhydrous or low water content polythiophene dispersion or solution that has only low metal and salt contents after the treatment.

However, in a method for subjecting 3,4-dialkoxythiophene to chemical oxidative polymerization in one stage, in the presence of a polyanion acting as a dopant, as in the methods described in JP7-90060A, JP2004-59666A, and International Publication No. WO 2009/131012, the control of the doping rate is difficult. In other words, undoped polyanions, that is, polyanions not contributing to conductivity, and the unreacted monomer are present in an excess amount, and this method is not considered to be sufficient as a production method for obtaining a conductive polymer with higher conductivity. In addition, a disadvantage of a capacitor including a solid electrolyte containing excess polyanions is that the reliability thereof, particularly the properties thereof in a higher humidity atmosphere, is poor.

A problem of the method described in JP2004-514753A is that the process for obtaining the dispersible powder is complicated. Problems of applying the method described in JP2009-1624A to a case where the number average molecular weight of polystyrenesulfonic acid is less than 50,000 are that the conductivity of the obtained conductive polymer decreases, and that the transparency also worsens. A problem of the method described in JP5-262981A is that it is difficult to disperse polyaniline when the molecular weight of polystyrene sulfonate is less than 50,000. In the method described in JP2002-206022A, an anhydrous or low water content polythiophene solution or dispersion is obtained, but a problem of the method is that it is not suitable as a method for obtaining a water dispersion.

It is an object of the present exemplary embodiment to solve the above problems and specifically to provide a conductive polymer having high conductivity and a method for producing the same, and a conductive polymer dispersion, and further provide a solid electrolytic capacitor having low ESR and a method for producing the same.

### SUMMARY OF THE INVENTION

The present inventors have diligently studied over and over, and, as a result, have found means for solving the above problems.

Specifically, a method for producing a conductive polymer according to the present exemplary embodiment includes the steps of:

dissolving a sulfonic acid group-containing resin having a weight average molecular weight of 2,000 or more and 50,000 or less and a compound represented by the following formula (1) in a solvent;

CₙHₙ₊₂(OH)ₙ (1)

wherein n represents an integer of 3 to 6,

mixing at least one monomer selected from pyrrole, thiophene, and derivatives thereof in an obtained solution;

subjecting the monomer to chemical oxidative polymerization, using a persulfate, to obtain a conductive polymer; and

washing the conductive polymer to remove the compound represented by the formula (1) contained in the conductive polymer.

A conductive polymer according to the present exemplary embodiment is obtained by the above production method. A conductive polymer dispersion according to the present exemplary embodiment is one obtained by wet-grinding and dispersing the above conductive polymer in water or a water-miscible organic solvent.

A solid electrolytic capacitor according to the present exemplary embodiment contains the above conductive polymer. A method for producing a solid electrolytic capacitor according to the present exemplary embodiment includes forming a solid electrolyte layer, using the above conductive polymer dispersion.

The present exemplary embodiment can provide a conductive polymer having high conductivity and a method for producing the same, and a conductive polymer dispersion, and further provide a solid electrolytic capacitor having low ESR and a method for producing the same.

### BRIEF DESCRIPTION OF THE DRAWING

FIG. 1 is a schematic cross-sectional view showing the structure of a solid electrolytic capacitor according to the present exemplary embodiment.

In the drawing, numerals have the following meanings. 1: anode conductor, 2: dielectric layer, 3: solid electrolyte layer, 3a: first solid electrolyte layer, 3b: second solid electrolyte layer, 4: cathode conductor, 4a: carbon layer, 4b: silver conductive resin layer.

### DETAILED DESCRIPTION OF THE PREFERRED EMBODIMENT

### Conductive Polymer and Method for Producing the Same

A method for producing a conductive polymer according to the present exemplary embodiment will be described below. A conductive polymer according to the present exemplary embodiment is obtained by the following method.

In the present exemplary embodiment, first, a sulfonic acid group-containing resin having a weight average molecular weight of 2,000 or more and 50,000 or less and a compound represented by the following formula (1) are dissolved in a solvent, and at least one monomer selected from pyrrole, thiophene, and derivatives thereof is mixed in the obtained solution.

CₙHₙ₊₂(OH)ₙ (1)

wherein n represents an integer of 3 to 6.

For the solvent, a solvent having good compatibility with the monomer is preferably selected, and the solvent may be water, an organic solvent, or a water-mixed organic solvent. Specific examples of the organic solvent include alcohol solvents, such as methanol, ethanol, and propanol; aromatic hydrocarbon solvents, such as benzene, toluene, and xylene; aliphatic hydrocarbon solvents, such as hexane; and aprotic polar solvents, such as N,N-dimethylformamide, dimethylsulfoxide, acetonitrile, and acetone. One organic solvent can be used, or two or more organic solvents can be used in combination. The organic solvent preferably contains at least one selected from water, alcohol solvents, and aprotic polar solvents, and is preferably water, ethanol, dimethylsulfoxide, or a mixed solvent of ethanol or dimethylsulfoxide and water.

The compound represented by the formula (1) is a type of sugar produced by the reduction of the carbonyl group of aldose or ketose and includes tritol wherein n=3, tetritol wherein n=4, pentitol wherein n=5, and hexitol wherein n=6. Specific examples of the compound represented by the formula (1) include glycerol (glycerin, n=3), erythritol (n=4), threitol (n=4), arabinitol (n=5), xylitol (n=5), ribitol (n=5), iditol (n=6), sorbitol (n=6), galactitol (n=6), and mannitol (n=6). Erythritol, xylitol, or sorbitol in which n is 4 or more and which is solid at ordinary temperature is preferred in order to obtain a polymer with higher conductivity. The compound represented by the formula (1) has high water solubility, and in the production of the conductive polymer, the flexibility of designing the amount of the compound added is high. The compound represented by the formula (1) is also preferred in terms of easy removal. In addition, the compound represented by the formula (1) is known as a food additive, and also has the advantage of high safety in handling.

The amount of the compound represented by the formula (1) used is not particularly limited as long as it is in a range in which the compound is dissolved in the solvent. But, the amount of the compound represented by the formula (1) used is preferably 0.5 to 30 times, more preferably 1 to 20 times, the molar amount of the sulfonic acid group-containing resin used.

For example, resins typified by polystyrene, polyester, polyvinyl, and the like, into which a sulfonic acid group is introduced, can be used as the sulfonic acid group-containing resin, which is a dopant. Specific examples of the sulfonic acid group-containing resin include polystyrenesulfonic acid, polyvinylsulfonic acid, polyestersulfonic acid, poly(2-acrylamide-2-methylpropanesulfonic acid), and copolymers having the structural units of these, and lithium salts, sodium salts, potassium salts, and ammonium salts thereof. One sulfonic acid group-containing resin can be used, or two or more sulfonic acid group-containing resins can be used in combination. Among them, polystyrenesulfonic acid having a structural unit represented by the following formula (2) is preferred. In addition, polyestersulfonic acid is also similarly preferred.

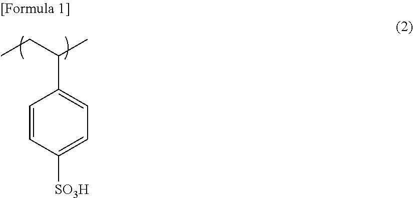

The weight average molecular weight of the sulfonic acid group-containing resin, which can be measured in gel permeation chromatography (GPC) is 2,000 or more and 50,000 or less in order to obtain a conductive polymer having high conductivity, and is preferably 2,000 or more and 30,000 or less, which provide higher compatibility and low viscosity, considering filterability during collection and washing in producing the conductive polymer.

As the monomer, a monomer selected from pyrrole, thiophene, and derivatives thereof is used. Specific examples of the pyrrole derivatives include 3-alkylpyrroles, such as 3-hexylpyrrole, 3,4-dialkylpyrroles, such as 3,4-dihexylpyrrole, 3-alkoxypyrroles, such as 3-methoxypyrrole, and 3,4-dialkoxypyrroles, such as 3,4-dimethoxypyrrole. Specific examples of the thiophene derivatives include 3,4-ethylenedioxythiophene and derivatives thereof, 3-alkylthiophenes, such as 3-hexylthiophene, and 3-alkoxythiophenes, such as 3-methoxythiophene. Among them, 3,4-ethylenedioxythiophene represented by the following formula (3) or derivatives thereof are preferred. Examples of the 3,4-ethylenedioxythiophene derivatives include 3,4-(1-alkyl)ethylenedioxythiophenes, such as 3,4-(1-hexyl)ethylenedioxythiophene. One monomer can be used, or two or more monomers can be used in combination.

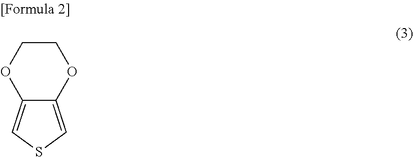

For the mixing proportion of the sulfonic acid group-containing resin and the monomer in the solvent, the sulfonic acid group-containing resin/monomer weight ratio is preferably in the range of 0.1 to 3.0 parts by weight, and is more preferably in the range of 0.3 to 1.8 parts by weight in order to obtain a conductive polymer having high conductivity with good yield.

Then, in the present exemplary embodiment, the above monomer is subjected to chemical oxidative polymerization, using a persulfate, to obtain a conductive polymer.

Persulfates, such as ammonium persulfate, sodium persulfate, and potassium persulfate, can be used as the oxidant for subjecting the above monomer to chemical oxidative polymerization, and ammonium persulfate is preferred. One persulfate can be used, or two or more persulfates can be used in combination. In the present exemplary embodiment, no metal oxidant is used, and therefore, an advantage thereof is that no metal component remains in the conductive polymer. The amount of the persulfate used is preferably 0.5 to 10 moles, more preferably in the range of 1 to 5 moles, with respect to 1 mole of the monomer, in order to allow the reaction to occur in a milder oxidizing atmosphere to obtain a conductive polymer having high conductivity.

The chemical oxidative polymerization of the monomer is preferably performed with stirring. The temperature of the chemical oxidative polymerization is not particularly limited, but is preferably 0 to 100° C., more preferably 10 to 50° C., with the reflux temperature of the solvent used, as the upper limit. If the temperature of the chemical oxidative polymerization is not appropriate, the conductivity of the obtained conductive polymer may decrease. The time of the chemical oxidative polymerization depends on the type and amount of the oxidant, the temperature, the stirring conditions, and the like, but is preferably about 5 to 100 hours. When the conductive polymer is produced by the chemical oxidative polymerization, the reaction liquid changes to dark navy blue to black.

The obtained conductive polymer has a structural unit derived from the monomer. For example, when 3,4-ethylenedioxythiophene represented by the formula (3) is used as the monomer, the obtained conductive polymer has a structural unit represented by the following formula (4).

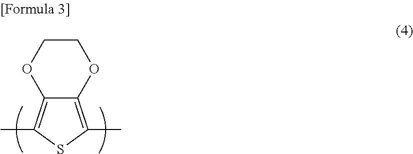

The chemical oxidative polymerization can also be performed in the presence of a surfactant. When the solubility of the monomer in the solvent is low, the dispersibility of the monomer can be improved by using the surfactant. The surfactant may be an anionic surfactant, a cationic surfactant, an amphoteric surfactant, or a nonionic surfactant, but dodecylbenzenesulfonic acid or polyethylene glycol is preferred. One surfactant can be used, or two or more surfactants can be used in combination. The amount of the surfactant used is preferably 0.01 to 10 parts by weight, more preferably 0.1 to 5 parts by weight, with respect to 1 part by weight of the monomer.

Then, in the present exemplary embodiment, the conductive polymer obtained above is washed to remove the compound represented by the formula (1) contained in the conductive polymer. Specifically, the conductive polymer is separated from the reaction liquid containing the conductive polymer obtained by the chemical oxidative polymerization, and washed to dissolve and remove the compound represented by the formula (1). Examples of the method for separating the conductive polymer from the reaction liquid include a filtration method and a centrifugation method.

A solvent capable of dissolving the compound of the formula (1), without dissolving the conductive polymer, is preferably used as the washing solvent. Specific examples of the washing solvent include water and hot water; alcohol solvents, such as methanol, ethanol, and propanol; and aprotic polar solvents, such as dimethylsulfoxide, N,N-dimethylformamide, and dimethylacetamide. One washing solvent can be used, or two or more washing solvents can be used in combination.

By also removing the unreacted dopant, the monomer, the oxidant, and an oxidant after the reaction at this time, a conductive polymer with higher purity can be obtained. Therefore, a solvent capable of dissolving these is preferably used.

The extent of the washing can be checked by the pH measurement, UV absorption analysis, or the like of the filtrate after the washing. The impurities contained in the conductive polymer can be quantified by atomic absorption spectroscopy, ICP emission analysis, ion chromatography, or the like.

The conductivity of the conductive polymer is determined by carrier density and electron mobility. Examples of one factor that determines electron mobility include orientation. In the present exemplary embodiment, it is presumed that by adding the compound represented by the formula (1) to the solvent, the interaction of the hydrogen bonding properties of the hydroxyl group of the compound and the sulfonic acid group of the sulfonic acid group-containing resin contained as a dopant causes a change in the orientation of the molecular chain of the sulfonic acid group-containing resin to improve the conductivity of the conductive polymer.

### <Conductive Polymer Dispersion>

A conductive polymer dispersion according to the present exemplary embodiment is obtained by wet-grinding and dispersing the above-described conductive polymer in water or a water-miscible organic solvent.

The wet grinding can be performed using general equipment, such as a ball mill, a bead mill, or a jet mill. A conductive polymer dispersion in which conductive polymer particles having a size of several tens of nm to 1 μm are dispersed is obtained by the wet grinding. The average particle diameter (D50) of the conductive polymer particles dispersed in the conductive polymer dispersion is preferably 30 to 800 nm, more preferably 30 to 600 nm, in terms of making the solid electrolyte layer of a solid electrolytic capacitor denser and have good adhesion. The particle diameter of the conductive polymer particles dispersed in the conductive polymer dispersion can be controlled by the size of the beads or the like used. The particle size distribution of the conductive polymer particles dispersed in the conductive polymer dispersion can be measured by a laser diffraction method, a dynamic light scattering method, or the like.

Water or a water-miscible organic solvent is used as the solvent. Specific examples of the organic solvent include protic polar solvents, such as methanol, ethanol, propanol, and acetic acid; and aprotic polar solvents, such as N,N-dimethylformamide, dimethylsulfoxide, acetonitrile, and acetone. The weight of the conductive polymer dispersed in the solvent is preferably 0.3 to 15 parts by weight, with respect to 100 parts by weight of the solvent, and is more preferably 0.5 to 8.0 parts by weight, in terms of obtaining good dispersibility.

It is also possible to further mix a polyacid component and a persulfate in order to further improve the dispersibility of the conductive polymer particles. In a case where a polyacid component and a persulfate are mixed, when the mixed liquid is allowed to stand at the early stage, and the color of the solvent is observed, it changes to a greenish color. Then, by stiffing the mixed liquid for a predetermined time for wet grinding, a dark navy blue conductive polymer dispersion is obtained. On the other hand, in the method in which no polyacid component or persulfate is mixed, such color change is not seen. Therefore, it is suggested that in the conductive polymer dispersion obtained by mixing the polyacid component and the persulfate, the doping of anions derived from the polyacid component occurs not a little.

A polyacid or a salt thereof can be used as the polyacid component. Specific examples of the polyacid include polycarboxylic acids, such as polyacrylic acid, polymethacrylic acid, and polymaleic acid; polysulfonic acids, such as polyvinylsulfonic acid, poly(2-acrylamide-2-methylpropanesulfonic acid), and polystyrenesulfonic acid; and copolymers having structural units thereof, and lithium salts, sodium salts, potassium salts, and ammonium salts thereof. Among them, polystyrenesulfonic acid having a structural unit represented by the above-described formula (2) is preferred. One polyacid component can be used, or two or more polyacid components can be used in combination.

The amount of the polyacid component mixed is preferably 0.2 to 5 parts by weight, more preferably 0.2 to 2.0 parts by weight, with respect to 1 part by weight of the conductive polymer, in order to obtain a good conductive polymer dispersion without impairing conductivity. The weight average molecular weight of the polyacid component is preferably 10,000 to 150,000, particularly preferably 10,000 to 70,000, in order to obtain a good conductive polymer dispersion without impairing conductivity.

As the persulfate, those similar to the above can be used. The amount of the persulfate mixed is preferably 0.5 to 10 parts by weight, more preferably 1 to 5 parts by weight, with respect to 1 part by weight of the conductive polymer, in order to obtain a good conductive polymer dispersion.

The temperature of the preparation of the conductive polymer dispersion is not particularly limited, but is preferably in the range of 0° C. to 100° C., more preferably 10° C. to 50° C. The time of the mixing of the components is not particularly limited, but is about 5 to 100 hours. The residual ions derived from the persulfate may be removed by subjecting the obtained conductive polymer dispersion to treatment using an ion exchange resin, or the like. A publicly known treatment technique corresponding to this can also be used instead. The conductive polymer dispersion according to the present exemplary embodiment usually exhibits a dark blue color.

### <Solid Electrolytic Capacitor and Method for Producing the Same>

The conductive polymer according to the present exemplary embodiment can be used as the solid electrolyte layer of a solid electrolytic capacitor. The conductivity of the conductive polymer is high, and therefore, a capacitor having low ESR can be obtained.

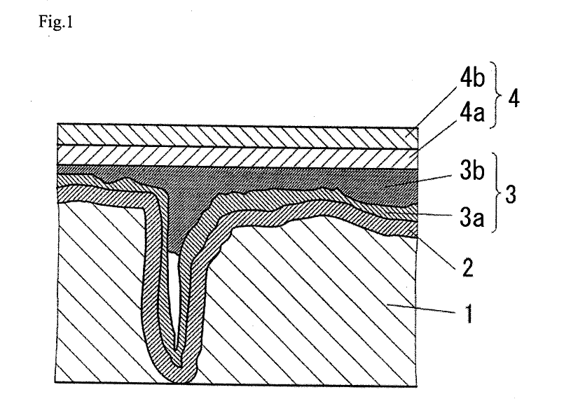

A schematic cross-sectional view showing the structure of a solid electrolytic capacitor according to the present exemplary embodiment is shown in FIG. 1. This solid electrolytic capacitor has a structure in which dielectric layer 2, solid electrolyte layer 3, and cathode conductor 4 are formed in this order on anode conductor 1.

Anode conductor 1 is formed of a plate, foil, or wire of a valve action metal; a sintered body of fine particles of a valve action metal; a porous body metal subjected to surface enlargement treatment by etching; or the like. Examples of the valve action metal include tantalum, aluminum, titanium, niobium, zirconium, and alloys thereof. Among them, at least one valve action metal selected from aluminum, tantalum, and niobium is preferred.

Dielectric layer 2 is a layer that can be formed by the electrolytic oxidation of a surface of anode conductor 1 and is also formed in the void portions of the sintered body, the porous body, or the like. The thickness of dielectric layer 2 can be appropriately adjusted by the voltage of the electrolytic oxidation.

Solid electrolyte layer 3 contains at least the above-described conductive polymer. Examples of the method for forming solid electrolyte layer 3 include a method for coating or impregnating dielectric layer 2 with the above-described conductive polymer dispersion and removing the solvent from the conductive polymer dispersion. The solvent may be only water or a mixed solvent containing water and a water-soluble organic solvent.

Solid electrolyte layer 3 can also be a two-layer structure of first solid electrolyte layer 3a and second solid electrolyte layer 3b, as shown in FIG. 1. This solid electrolyte layer 3 can be formed as follows. First, dielectric layer 2 is alternately immersed in a monomer solution providing a conductive polymer and a solution containing an oxidant and a dopant for chemical oxidative polymerization. This is repeated any number of times to form first solid electrolyte layer 3a containing the conductive polymer. Then, first solid electrolyte layer 3a is coated or impregnated with the above-described conductive polymer dispersion, and the solvent is removed from the conductive polymer dispersion to form second solid electrolyte layer 3b.

At least one selected from pyrrole, thiophene, aniline, and derivatives thereof can be used as the monomer. Sulfonic acid compounds, such as alkylsulfonic acid, benzenesulfonic acid, naphthalenesulfonic acid, anthraquinonesulfonic acid, camphorsulfonic acid, and derivatives thereof, are preferred as the dopant used in subjecting the monomer to chemical oxidative polymerization to obtain the conductive polymer.

For the conductive polymer contained in first solid electrolyte layer 3a, and the conductive polymer contained in second solid electrolyte layer 3b, at least polymers of the same type are preferably contained.

Solid electrolyte layer 3 may further contain an oxide derivative, such as manganese dioxide or ruthenium oxide; or an organic semiconductor, such as TCNQ (7,7,8,8,-tetracyanoquinodimethane complex salt).

The coating or impregnation method is not particularly limited, but repeated work, a reduced-pressure method, and a pressure method are also possible in order to sufficiently fill the interior of the porous pores with the conductive polymer.

The removal of the solvent from the conductive polymer dispersion can be performed by drying the conductive polymer. The drying temperature is not particularly limited as long as it is in a temperature range in which the solvent removal is possible. But, the upper limit temperature is preferably less than 300° C., in terms of preventing element degradation due to heat. The drying time needs to be appropriately optimized according to the drying temperature. But, the drying time is not particularly limited as long as it is in a range in which the conductivity is not impaired.

Cathode conductor 4 is not particularly limited as long as it is a conductor. But, cathode conductor 4 can be, for example, a two-layer structure of carbon layer 4a of graphite or the like, and silver conductive resin 4b.

### EXAMPLES

The present exemplary embodiment will be more specifically described below, based on Examples, but the present exemplary embodiment is not limited only to these Examples.

### Example 1

8.1 g of erythritol as a compound of the formula (1), and 13.5 g of an aqueous solution containing 20% by weight of polystyrenesulfonic acid (weight average molecular weight: 14,000) as a sulfonic acid group-containing resin were introduced into 80 g of water, and the mixture was stirred at ordinary temperature for 30 minutes. Then, 6.68 g of 3,4-ethylenedioxythiophene as a monomer was mixed into this solution, and then, the solution was further stirred at room temperature for 30 minutes.

Then, 18.1 g of an aqueous solution containing 40% by weight of ammonium persulfate as an oxidant was added to this solution in equally divided amounts, five times, at intervals of 10 minutes, and then, the solution was stirred at room temperature for 50 hours to perform chemical oxidative polymerization to synthesize poly(3,4-ethylenedioxythiophene). At this time, the solution changed from yellow to black through light green, green, and light navy blue.

Then, this reaction solution was subjected to suction filtration, using filter paper with a retained particle diameter of 4 μm (No. 5B, Kiriyama Glass Works Co.). At this time, the filtrate was colorless, and the obtained polymer did not pass through the filter paper, and the polymer was all recovered. In other words, the solids of the polymer all had a diameter of 4 μm or more. The obtained polymer was washed with pure water to remove the erythritol, the excess oxidant, and the unreacted dopant. The washing with pure water was repeated until the pH of the filtrate was 6 to 7. Then, the polymer was washed with ethanol to remove the unreacted monomer. The washing with ethanol was performed until the filtrate was colorless and transparent. Then, the obtained polymer was dried in the air at 120° C. for 1 hour to remove moisture to obtain a conductive polymer. At this time, the conductive polymer exhibited a pale navy blue color.

The filtration rate (relative comparison) during the filtration and washing in collecting the polymer from the reaction liquid, and the yield and conductivity of the conductive polymer are shown in Table 1. The filtration rate was evaluated as “very good” when it was relatively overwhelmingly fast, as “good” when it was relatively fast, and as “fair” when it was relatively slow. In addition, the conductivity (S/cm) of the conductive polymer was calculated from results obtained by press-forming the obtained conductive polymer to fabricate pellets, forming a conductive polymer film using the pellets, and then measuring the surface resistance (Ω/□) and film thickness of the conductive polymer film by a four-terminal method.

### Examples 2 to 7

A conductive polymer was obtained as in Example 1, except that the compound of the formula (1), the sulfonic acid group-containing resin, and the sulfonic acid group-containing resin/monomer weight ratio were changed as shown in Table 1. The filtration rate (relative comparison) during the filtration and washing in collecting the polymer from the reaction liquid, and the yield and conductivity of the conductive polymer are shown in Table 1.

### Comparative Example 1

A conductive polymer was obtained as in Example 1, except that no additives were added. The filtration rate (relative comparison) during the filtration and washing in collecting the polymer from the reaction liquid, and the yield and conductivity of the conductive polymer are shown in Table 1.

TABLE 1

| | | Sulfonic acid group-containing resin | | Sulfonic acid | Filtration | | |
|---|---|---|---|---|---|---|---|
| | Compound | | Weight average | group-containing | rate | Conductive polymer | |
| | of formula | | molecular | resin/monomer | (relative | Yield | Conductivity |
| | (1) | Type | weight | weight ratio | comparison) | (g) | (S/cm) |
| Example 1 | Erythritol | Polystyrenesulfonic | 14,000 | 0.4 | Very good | 7.33 | 44.7 |
| | | acid | | | | | |
| Example 2 | Erythritol | Polystyrenesulfonic | 14,000 | 1.6 | Good | 6.13 | 35.1 |
| | | acid | | | | | |
| Example 3 | Erythritol | Polystyrenesulfonic | 14,000 | 0.1 | Very good | 5.15 | 28.1 |
| | | acid | | | | | |
| Example 4 | Erythritol | Polystyrenesulfonic | 50,000 | 0.4 | Fair | 7.40 | 28.3 |
| | | acid | | | | | |
| Example 5 | Erythritol | Polyestersulfonic | 25,000 | 0.4 | Good | 7.16 | 38.7 |
| | | acid | | | | | |
| Example 6 | Sorbitol | Polystyrenesulfonic | 14,000 | 0.4 | Very good | 7.28 | 45.6 |
| | | acid | | | | | |
| Example 7 | Glycerin | Polystyrenesulfonic | 14,000 | 0.4 | Very good | 6.32 | 32.5 |
| | | acid | | | | | |
| Comparative | None | Polystyrenesulfonic | 50,000 | 0.4 | Fair | 5.13 | 10.9 |
| Example 1 | | acid | | | | | |

As described above, it was confirmed that the conductive polymers obtained in Examples 1 to 7 all had higher conductivity than the conductive polymer obtained in Comparative Example 1, and further, the conductive polymers obtained in Examples 1 to 7 also had high yield and good filterability.

### Example 8

0.5 g of the conductive polymer obtained in Example 1, 50 g of water, and an appropriate amount of 0.5 mmφzirconia beads were introduced into a pot mill and wet-ground (stirred at 500 rpm for 24 hours) to obtain a conductive polymer dispersion. The obtained conductive polymer dispersion exhibited a dark navy blue color, and the pH thereof was 2.60. In addition, the particle size distribution of the conductive polymer particles dispersed in the conductive polymer dispersion was measured by a laser diffraction method, and their average particle diameter (D50) was 526 nm.

### Example 9

0.5 g of the conductive polymer obtained in Example 1 was introduced into 50 g of water, and then, 1.5 g of an aqueous solution containing 20% by weight of polystyrenesulfonic acid (weight average molecular weight: 50,000), and 1.6 g of an aqueous solution containing 40% by weight of ammonium persulfate were introduced. The mixture was stirred for 100 hours. Using the obtained solution and an appropriate amount of 0.5 mmφzirconia beads, wet grinding was performed as in Example 8 to obtain a conductive polymer dispersion. The obtained conductive polymer dispersion exhibited a dark navy blue color, and the pH thereof was 1.9. In addition, the particle size distribution of the conductive polymer particles dispersed in the conductive polymer dispersion was measured by the laser diffraction method, and their average particle diameter (D50) was 467 nm

### Example 10

3 g of an ion exchange resin (manufactured by ORGANO CORPORATION, product name: MB-1, ion exchange type: —H, —OH) was added to 10 g of the conductive polymer dispersion obtained in Example 9, and the mixture was stirred for 1 hour. Then, the ion exchange resin was removed to obtain a conductive polymer dispersion. The obtained conductive polymer dispersion exhibited a dark navy blue color, and the pH thereof was 2.52. In addition, the particle size distribution of the conductive polymer particles dispersed in the conductive polymer dispersion was measured by the laser diffraction method, and their average particle diameter (D50) was 501 nm.

### Comparative Example 2

A conductive polymer dispersion was obtained as in Example 8, except that the conductive polymer obtained in Comparative Example 1 was used. The obtained conductive polymer dispersion exhibited a dark navy blue color, and the pH thereof was 2.61. In addition, the particle size distribution of the conductive polymer particles dispersed in the conductive polymer dispersion was measured by the laser diffraction method, and their average particle diameter (D50) was 531 nm.

### Examples 11 to 13 and Comparative Example 3

Using porous aluminum as an anode conductor of a valve action metal, an oxide film, which was a dielectric layer, was formed on a surface of the aluminum by anodic oxidation. Then, the anode conductor on which the dielectric layer was formed was repeatedly alternately immersed in and pulled up from a monomer liquid in which 10 g of pyrrole as a monomer was dissolved in 200 ml of pure water, and a solution in which 30 g of iron(III) p-toluenesulfonate salt as a dopant and oxidant was dissolved in 200 ml of pure water, 10 times, to perform chemical oxidative polymerization to form a first solid electrolyte layer.

Each of the conductive polymer dispersions produced in Examples 8 to 10 and Comparative Example 2 was dropped on the first solid electrolyte layer, and dried and solidified at 150° C. to form a second solid electrolyte layer. Then, a graphite layer and a silver-containing resin layer were formed in order on the second solid electrolyte layer to obtain a solid electrolytic capacitor.

The ESR (equivalent series resistance) of the obtained solid electrolytic capacitor was measured using an LCR meter at a frequency of 100 kHz. The value of the ESR for the total area of the cathode portion was normalized to that for a unit area (1 cm²). The result is shown in Table 2.

TABLE 2

| | Conductive polymer dispersion | | |
|---|---|---|---|
| | | Average particle | ESR |
| | Type | diameter (D50) (nm) | (mΩ · cm) |
| Example 11 | Example 8 | 526 | 2.0 |
| Example 12 | Example 9 | 467 | 1.8 |
| Example 13 | Example 10 | 501 | 1.8 |
| Comparative | Comparative | 531 | 3.4 |
| Example 3 | Example 2 | | |

As described above, in the solid electrolytic capacitors obtained in Examples 11 to 13, the conductivity of the conductive polymer was high, and it was possible to reduce the resistance of the solid electrolyte. Therefore, the resistance (ESR) of the solid electrolytic capacitors was reduced.

Here, the results of Examples 11 to 13 are compared. The ESR of the solid electrolytic capacitors obtained in Examples 12 and 13 was further reduced, compared with that of the solid electrolytic capacitor obtained in Example 11. This is considered to be due to the particle diameter distribution of the conductive polymer particles dispersed in the conductive polymer dispersions. In other words, this is considered to be because the conductive polymer particles dispersed in the conductive polymer dispersions in Example 9 and 10 in which the polyacid and the persulfate were mixed had a small average particle diameter (D50), and therefore, a denser solid electrolyte layer with good adhesion was formed. Therefore, it has been found that in addition to the conductivity of the conductive polymer, the use of a conductive polymer dispersion with good dispersibility is also important to reduce the ESR of a solid electrolytic capacitor.

As described above, according to the present exemplary embodiment, a conductive polymer having high conductivity can be obtained with good yield, and a solid electrolytic capacitor having low ESR can be provided by using the conductive polymer.

What is claimed is:

1. A method for producing a conductive polymer, comprising the steps of:
dissolving a sulfonic acid group-containing resin having a weight average molecular weight of 2,000 or more and 50,000 or less and a compound represented by the following formula (1) in a solvent;
CₙHₙ₊₂(OH)ₙ (1)
wherein n represents an integer of 3 to 6,
mixing at least one monomer selected from pyrrole, thiophene, and derivatives thereof in an obtained solution;
subjecting the monomer to chemical oxidative polymerization, using a persulfate, to obtain a conductive polymer; and
washing the conductive polymer to remove the compound represented by the formula (1) contained in the conductive polymer.

2. The method for producing a conductive polymer according to claim 1, wherein the compound represented by the formula (1) is at least one selected from erythritol, xylitol, and sorbitol.

3. The method for producing a conductive polymer according to claim 1, wherein the sulfonic acid group-containing resin is polystyrenesulfonic acid or polyestersulfonic acid.

4. The method for producing a conductive polymer according to claim 1, wherein at least 3,4-ethylenedioxythiophene is used as the monomer.

5. A conductive polymer obtained by a method for producing a conductive polymer according to claim 1.

6. A conductive polymer dispersion obtained by wet-grinding and dispersing a conductive polymer according to claim 5 in water or a water-miscible organic solvent.

7. The conductive polymer dispersion according to claim 6, obtained by further mixing a polyacid component and a persulfate.

8. The conductive polymer dispersion according to claim 7, wherein the polyacid component is polystyrenesulfonic acid.

9. A solid electrolytic capacitor comprising a solid electrolyte layer comprising a conductive polymer according to claim 5.

10. A method for producing a solid electrolytic capacitor, comprising forming a solid electrolyte layer, using a conductive polymer dispersion according to claim 6.
